(19) United States
(12) Patent Application Publication
(10) Pub. No.: US 2020/0102980 A1
(43) Pub. Date: Apr. 2, 2020

(54) WOOD SCREW

(71) Applicants: KUO-TAI HSU, TAINAN CITY (TW); MING-HAO HSU, TAINAN CITY (TW)

(72) Inventors: KUO-TAI HSU, TAINAN CITY (TW); MING-HAO HSU, TAINAN CITY (TW)

(21) Appl. No.: 16/145,791

(22) Filed: Sep. 28, 2018

(51) Int. Cl. F16B 25/10; F16B 25/00

(52) U.S. Cl. CPC F16B 25/103; F16B 25/0084; F16B 25/0015

(57) ABSTRACT

A wood screw is disclosed herein. It comprises a screw head and a rod integrally connected to a bottom of the screw head and having a first section and a second section, wherein the first section has a straight surface surrounded with a screw thread and the second section is connected to a bottom of the first section and has a tapered straight surface, on which at least one cutting unit is formed, each of the at least one cutting unit enabling to form a state of a concave, a convex or combination thereof.

### BACKGROUND OF THE INVENTION

### 1. Field of the Invention

The present invention relates to a wood screw which is particularly used for wood materials and has efficiency of conveniently drilling and screwing into a work piece and removing chips.

### 2. Description of Related Art

Various types of screws with different structural designs are used for screwing and bonding objects or applied in different situations. For instance, the screws comprises machine screw, tapping screw, wood screw, drilling screw and the like and are used in different places to screw objects with different degrees of hardness. Specifically, the machine screw is used in precision machinery and matched with an appropriate nut and thread. The drilling screw, also known as self-drilling screw or iron plate screw, is often used in the construction industry for screwing plates, construction cement and the like. The wood screw is widely used to fasten or bond a wooden work piece as well as non-steel materials, e.g. wood, plywood, gypsum board and the like.

In addition to different uses, the structures of various types of screws are also different. The drilling screw comprises a screw head, a rod body surrounded with screw threads, a straight drill part connected to the rod body, a tapered surface connected to a bottom of the straight drill part, and a cutting edge extended from a center of the tapered surface towards the straight drill part. The cutting edge of the straight drill part is used to drill a metal plate to form a straight section aperture, and then the drilling screw is screwed into the straight section aperture of the metal plate for bonding by the screw threads on its rod body. The basic design of the drilling screw was also developed in response to the rigidity, hardness and ductility of metal materials.

Different from the structure and use of the drilling screw, the wood screw is used for wood materials. Since the wood materials are not rigid and rich in fiber, the wood screws must have the function of cutting fibers to facilitate drilling into the depths of the wood materials. Referring to FIG. 10 and FIG. 11, a wood screw of a prior art comprises a screw head (3) and a rod body (4) integrally extended downwardly from the screw head (3). The rod body (4) comprises a flat end (41), a tapered end (42), and a screw thread part (43) surrounded on the rod body (4) from the flat end (41) to the tapered end (42) so that the wood screw can be screwed into a work piece by the tapered end (42) and lock in the work piece by the screw thread part (43). However, the abovementioned wood screw is not easy to screw into the work piece because it does not drill first. When the tapered end (42) is screwed in to the work piece, the screw thread part (43) on the tapered end (42) is forced to apply force to screw forwards to a wooden work piece mainly by twisting and cutting fibers. During the screwing process, the screw thread part (43) on the tapered end (42) cuts and forms a mating female screw thread which creates resistance to hinder screwing of the wood screw. Furthermore, wood shavings are usually produced and remained in the screw thread part (43) to produce frictional resistance when the screw thread part (43) is drilled into the wooden work piece. If the wood shavings are piled up and cannot be discharged from an aperture of the wooden work piece, the aperture are easily squeezed by the screw thread part (43) to cause cracking, resulting in damage to the structure of the wooden work piece and a decrease in strength and durability.

Accordingly, in actual use, the wood screw of the prior art still has disadvantages of difficulty in screwing due to resistance of the wood shavings, time consuming, and easily causing cracking of the wooden work piece due to the wood shavings accumulated and squeezed in its aperture.

### SUMMARY OF THE INVENTION

In view of the above-mentioned problems, the object of the present invention is to provide a wood screw which is particularly used for wood materials and has efficiency of conveniently drilling and screwing into a work piece and removing chips.

The wood screw comprises a screw head and a rod. The screw head is disposed at a top of the rod. The rod has a first section and a second section. The first section has a straight surface surrounded with a screw thread and the second section is connected to a bottom of the first section and has a tapered straight surface, on which at least one cutting unit is formed. The at least one cutting unit enables to form a state of a concave, a convex or combination thereof to achieve the convenience of screwing in and chip removal.

According to an embodiment of the present invention, the at least one cutting unit is a groove which has functions of cutting fibers and accommodating chips to prevent the accumulation of wood shavings when the wood screw is screwed in.

According to an embodiment of the present invention, the at least one cutting unit is a rib which has functions of chopping fibers and removing chips to prevent the accumulation of wood shavings when the wood screw is screwed in.

According to an embodiment of the present invention, the at least one cutting unit comprises a groove and a rib connected to one side of the groove so as to have functions of cutting and chopping fibers and increased effects of accommodating and removing chips.

According to an embodiment of the present invention, the at least one cutting unit is connected to or intersected with the screw thread of the first section, or formed with a hollow section at a junction with the screw thread of the first section.

According to an embodiment of the present invention, the length of the second section is determined by the number of the at least one cutting unit.

According to an embodiment of the present invention, the groove or the rib has a semi-circular cross section, a triangular cross section or a rectangular cross section.

### BRIEF DESCRIPTION OF THE DRAWINGS

FIG. 1 is a stereogram showing a first embodiment for a wood screw having one screw thread according to the present invention;

FIG. 2 is a partial enlarged view showing the first embodiment for the wood screw having one groove;

FIG. 3 is a partial enlarged view showing the first embodiment for the wood screw having two grooves;

FIG. 4 is a stereogram showing a second embodiment for a wood screw having one screw thread according to the present invention;

FIG. 5 is a partial enlarged view showing the second embodiment for the wood screw having one rib;

FIG. 6 is a partial enlarged view showing the second embodiment for the wood screw having two ribs;

FIG. 7 is a partial enlarged view showing a third embodiment for a wood screw having one groove;

FIG. 8 is a partial enlarged view showing the third embodiment for the wood screw having two grooves;

FIG. 9 is a schematic diagram showing a cutting unit (a) connected to or (b) intersected with the screw thread of the first section, or (c) formed with a hollow section at a junction with the screw thread of the first section;

FIG. 10 is a schematic diagram showing a prior art;

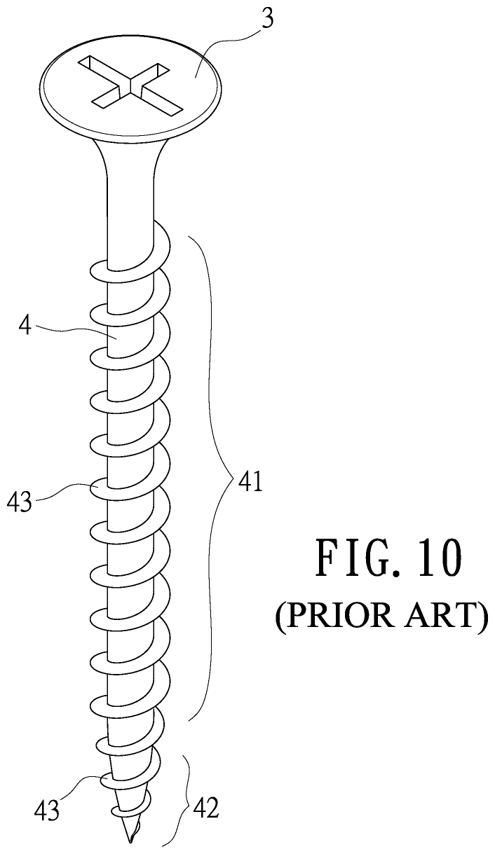

FIG. 11 is a partial enlarged view showing a prior art.

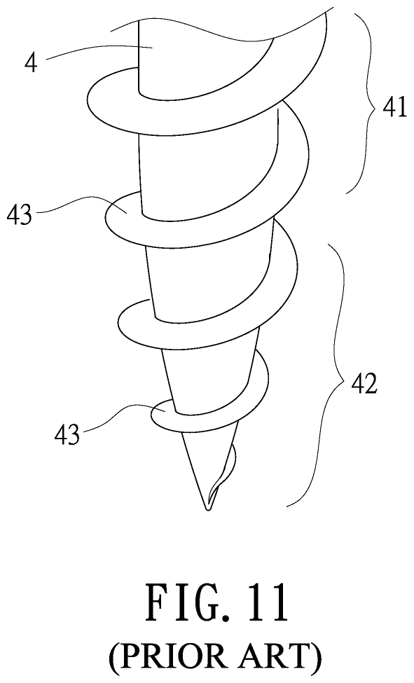

### DETAILED DESCRIPTION OF THE PREFERRED EMBODIMENT

Hereinafter, an exemplary embodiment of the present invention is will be described in detail with reference to the accompanying drawings.

A wood screw according to the present invention is disclosed herein. It mainly comprises screw head and a rod. The screw head is disposed at a top of the rod, and the rod has a first section and a second section. The first section has a straight surface surrounded with a screw thread and the second section is connected to a bottom of the first section and has a tapered straight surface. At least one cutting unit is formed on the tapered straight surface of the second section. The at least one cutting unit enables to form a state of a concave, a convex or combination thereof to achieve the convenience of screwing in and chip removal.

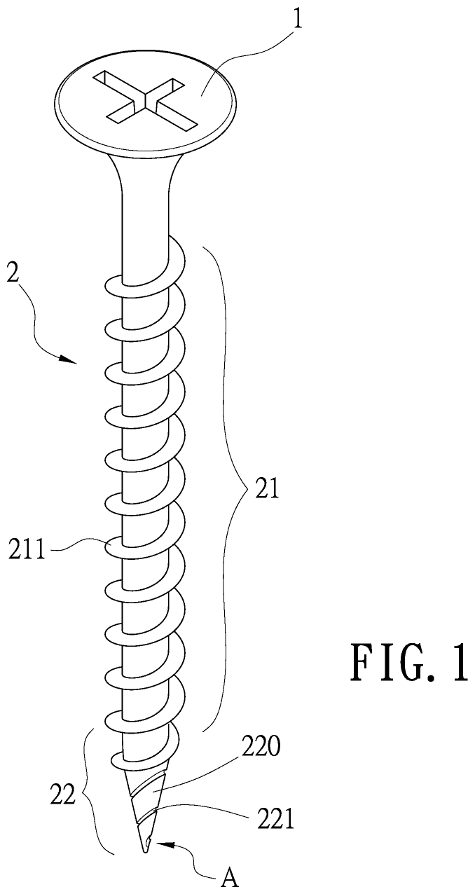

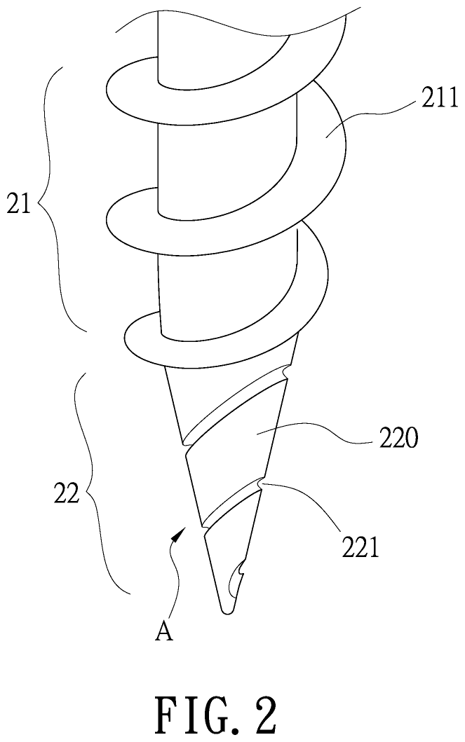

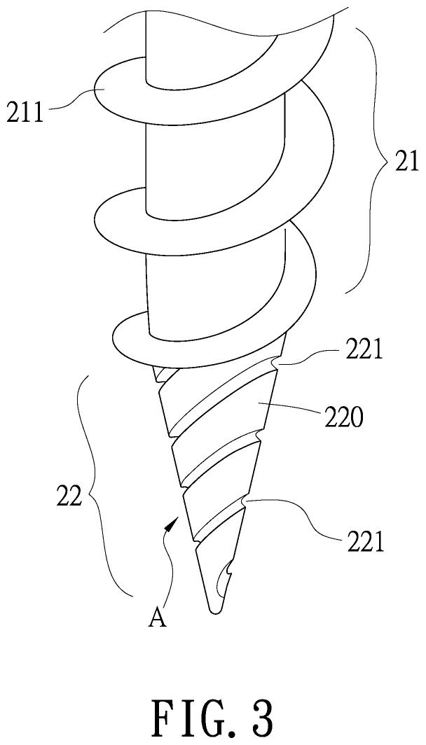

A first embodiment for a wood screw having one screw thread according to the present invention is disclosed in FIG. 1 to FIG. 3. It comprises a screw head (1) and a rod (2) integrally connected to a bottom of the screw head (1). The rod (2) comprises a first section (21) and a second section (22). The first section (21) has a straight surface surrounded with a screw thread (211). The second section (22) is connected to a bottom of the first section (21) and has a tapered straight surface (220) and at least one cutting unit (A) formed on the tapered straight surface (220). The at least one cutting unit (A) is at least one groove (221). For instance, as shown in FIG. 1 and FIG. 2, the wood screw has one groove (221), and as shown in FIG. 3, the wood screw has two grooves (221). Furthermore, the at least one groove (221) is obliquely disposed on the tapered straight surface (220) (not shown in FIG. 1 to FIG. 3) or spirally disposed on the tapered straight surface (220) (as shown in FIG. 1 to FIG. 3).

In a practical use, a sharp end of the second section (22) of the wood screw is pierced into an end face of an un-drilled wooden work piece for screwing. When the second section (22) is screwed into the wooden work piece, the screwing resistance can be reduced due to the tapered straight surface (220), so that the wood screw is easily and quickly screwed into the wooden work piece. The at least one groove (221) has a sharp angle cutting surface for efficiently and quickly cutting wood fibers of the wooden work piece. Then, the wood shavings produced by the cutting can be further accommodated by the at least one groove (221), and the wood shavings are discharged from the wood screw by the screw thread (211) of the first section (21).

The second section (22) of the wood screw of the present invention has a design of the tapered straight surface (220) without screw thread, so that the second section (22) can be smoothly screwed into the wooden work piece or a low-rigidity material under low resistance conditions. In such a case, the disadvantage of the prior art that the mating female screw thread is formed to create resistance and further hinder screwing of the wood screw during the cutting process of the screw thread part on the tapered end is solved.

Accordingly, the tapered straight surface (220) of the second section (22) of the wood screw has efficiency of conveniently drilling and screwing into the wooden work piece for further cutting by the at least one groove (221) and accommodating the wood shavings produced by the cutting. During the cutting process, the at least one groove (221) can be used to assist the second section (22) in quickly screwing into the wooden work piece and discharging the wood shavings, so that the screw speed of the wood screw is increased

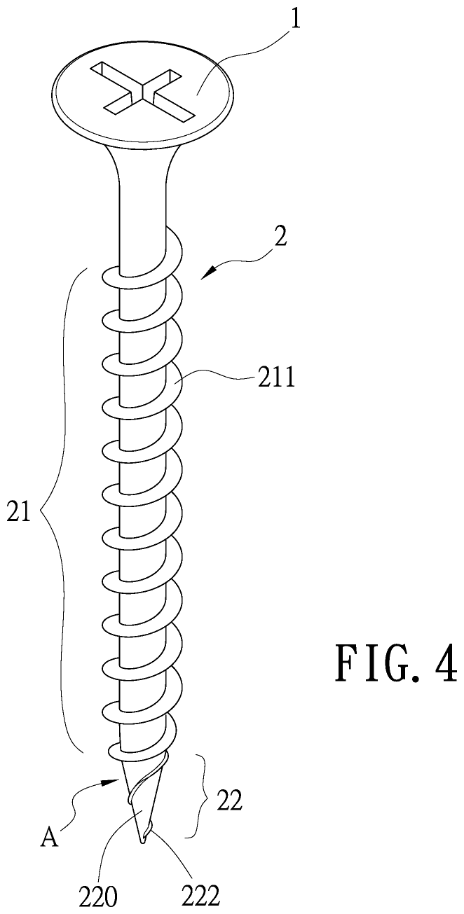

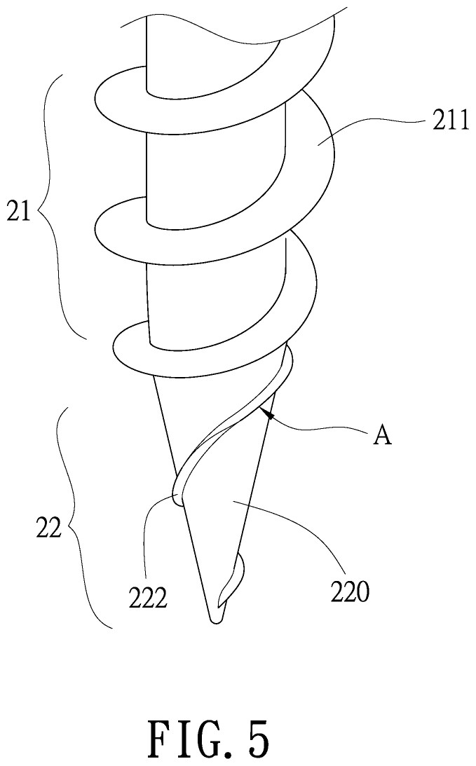

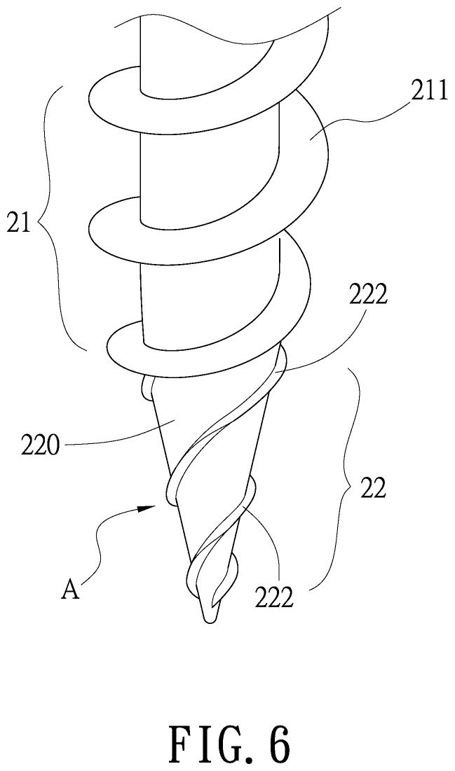

A second embodiment for a wood screw having one screw thread according to the present invention is disclosed in FIG. 4 to FIG. 6. It comprises a screw head (1) and a rod (2) integrally connected to a bottom of the screw head (1). The rod (2) comprises a first section (21) and a second section (22). The first section (21) has a straight surface surrounded with a screw thread (211). The second section (22) is connected to a bottom of the first section (21) and has a tapered straight surface (220) and at least one rib (222) on the tapered straight surface (220). For instance, as shown in FIG. 4 and FIG. 5, the wood screw has one rib (222), and as shown in FIG. 6, the wood screw has two ribs (222). Furthermore, the at least one rib (222) is obliquely disposed on the tapered straight surface (220) (not shown in FIG. 4 to FIG. 6) or spirally disposed on the tapered straight surface (220) (as shown in FIG. 4 to FIG. 6).

In a practical use, a sharp end of the second section (22) of the wood screw is pierced into an end face of an un-drilled wooden work piece for screwing. When the second section (22) is screwed into the wooden work piece, the screwing resistance can be reduced due to the tapered straight surface (220), so that the wood screw is easily and quickly screwed into the wooden work piece. The at least one rib (222) can efficiently and quickly cut wood fibers of the wooden work piece. Then, the wood shavings produced by the cutting can be further discharged from the wood screw by a space between the at least one rib (222) and the tapered straight surface (220) of the second section (22) and by assist of the screw thread (211) of the first section (21). In this way, the wood screw can be more easily and quickly screwed into the wooden work piece to achieve efficiency of firmly screwing and locking the wooden work piece.

Furthermore, the second section (22) of the wood screw of the present invention has a design of the tapered straight surface (220) without screw thread, so that the second section (22) can be smoothly screwed into the wooden work piece or a low-rigidity material under low resistance conditions. In such a case, the disadvantage of the prior art that the mating female screw thread is formed to create resistance and further hinder screwing of the wood screw during the cutting process of the screw thread part on the tapered end is solved.

Accordingly, the tapered straight surface (220) of the second section (22) of the wood screw has efficiency of conveniently drilling and screwing into the wooden work piece for further cutting the wood fibers by a sharp angle cutting surface of the at least one rib (222). During the cutting process, the at least one rib (222) can be used to drill an aperture in advance to assist the second section (22) in quickly screwing into the wooden work piece and discharging the wood shavings, so that the screw speed of the wood screw is increased.

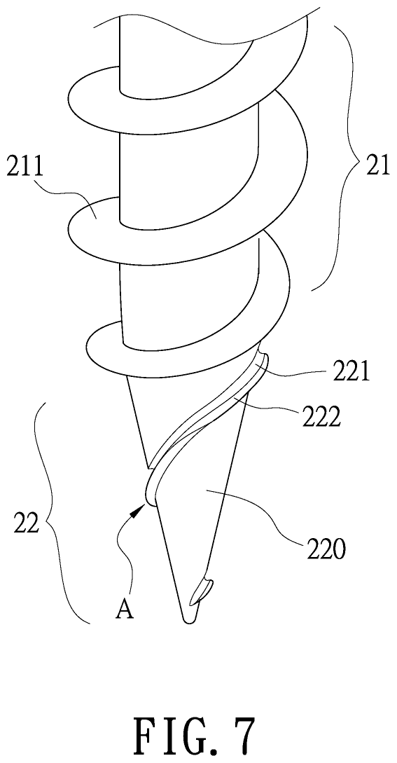

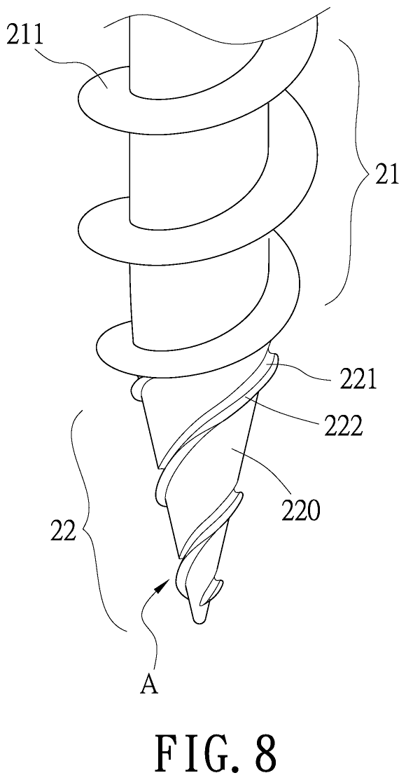

A third embodiment for a wood screw according to the present invention is disclosed in FIG. 7 and FIG. 8.

It comprises a screw head (1) and a rod (2) integrally connected to a bottom of the screw head (1). The rod (2) comprises a first section (21) and a second section (22). The first section (21) has a straight surface surrounded with a screw thread (211). The second section (22) is connected to a bottom of the first section (21) and has a tapered straight surface (220) and at least one cutting unit (A) formed on the tapered straight surface (220). The at least one cutting unit (A) comprises a groove (221) recessed in the tapered straight surface (220) and a rib (222) connected to one side of the groove (221) and protruded from the tapered straight surface (220).

As shown in FIG. 7, the at least one cutting unit (A) of the wood screw has one groove (221), and as shown in FIG. 8, the wood screw has two grooves (221). Furthermore, the at least one cutting unit (A) is obliquely disposed on the tapered straight surface (220) (not shown in FIG. 1 to FIG. 3) or spirally disposed on the tapered straight surface (220) (as shown in FIG. 7 and FIG. 8).

In a practical use, the third embodiment is like the operation of the above two embodiments and combines the effects of the above two embodiments.

A sharp end of the second section (22) of the wood screw is pierced and screwed into a wooden work piece. When the second section (22) is screwed into the wooden work piece, a sharp angle cutting surfaces of the groove (221) and the rib (222) efficiently and quickly cut wood fibers of the wooden work piece. During the cutting process, the groove (221) and the rib (222) can be used to drill an aperture in advance to assist the second section (22) in quickly screwing into the wooden work piece and increase a space for accommodating the wood shavings and effect of discharging the wood shavings, so that the screw speed of the wood screw is increased.

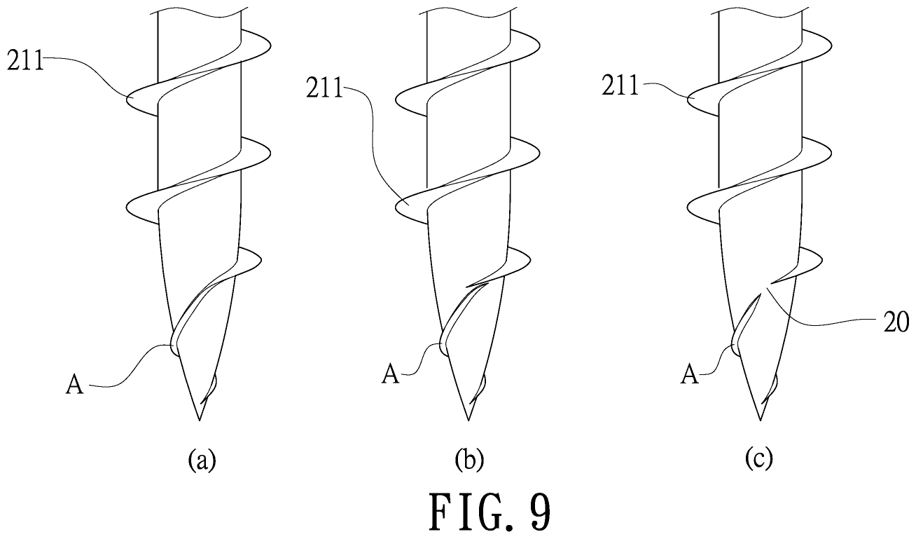

Furthermore, referring to FIG. 9, the at least one cutting unit (A) is connected to or intersected with the screw thread (211) of the first section (21) as shown in FIG. 9-(a) and FIG. 9-(b), respectively, or formed with a hollow section (20) at a junction with the screw thread (211) of the first section (21) as shown in FIG. 9-(c). The length of the second section (22) is determined by the number of the at least one cutting unit (A). The spiral angles of the groove (221) and the rib (222) of the at least one cutting unit (A) can be adjusted corresponding to different hardness of the wooden work pieces, so a sharp end of the second section (22) gradually cuts the wooden work pieces, and the wood shavings are discharged from the wooden work piece by a rotation of the at least one cutting unit (A). Accordingly, the more the cutting unit (A), the faster the wood shavings of the wooden work piece can be removed. Additionally, within a certain range, the larger spiral angle can increase the number of cutting units (A) on the second section (22) for screwing. In such a case, the impact of screwing process is reduced and the smoothness of screwing process is increased at the same time, but the axial resistance is also increased. In the embodiments of the present invention, the groove (221) or the rib (222) has a semi-circular cross section, a triangular cross section or a rectangular cross section.

Compared with the technique available now, the present invention has the following advantages:

1. The second section of the wood screw of the present invention has a design of the tapered straight surface without screw thread, so that the second section can be smoothly and quickly screwed into the wooden work piece under low resistance conditions.

2. The second section of the wood screw of the present invention has a design of the groove for efficiently cutting the wood fibers of the wooden work piece and accommodating the wood shavings, and the screw thread of the first section assists in removing the wood shavings during the screwing process, so that the wood screw can be more easily and quickly screwed into the wooden work piece to achieve efficiency of firmly screwing and locking the wooden work piece.

3. The second section of the wood screw of the present invention has a design of the rib for efficiently cutting wood fibers of the wooden work piece and removing the wood shavings by the space between the rib and the tapered straight surface of the second section and by assist of the screw thread of the first section, so that the wood screw can be more easily and quickly screwed into the wooden work piece to achieve efficiency of firmly screwing and locking the wooden work piece.

4. The second section of the wood screw of the present invention has a design with both the groove and the rib for cutting and chopping fibers at the same time, so the groove and the rib can be used to drill an aperture in advance during the cutting process to assist the second section in quickly screwing into the wooden work piece and increase a space for accommodating the wood shavings and effect of discharging the wood shavings, and the screw speed of the wood screw is increased.

What is claimed is:

1. A wood screw, comprising:
a screw head; and
a rod integrally connected to a bottom of the screw head and having a first section and a second section, wherein the first section has a straight surface surrounded with a screw thread and the second section is connected to a bottom of the first section and has a tapered straight surface, on which at least one cutting unit is formed, and wherein the at least one cutting unit comprises a groove recessed in the tapered straight surface and a rib connected to one side of the groove and protruded from the tapered straight surface.

2. The wood screw as claimed in claim 1, wherein the at least one cutting unit is connected to or intersected with the screw thread of the first section, or formed with a hollow section at a junction with the screw thread of the first section.
